(19) United States
(12) Patent Application Publication
(10) Pub. No.: US 2014/0214691 A1
(43) Pub. Date: Jul. 31, 2014

(54) COMPUTER SOFTWARE SYSTEM AND METHOD FOR INNOVATION MANAGEMENT

(71) Applicant: Langdon Emmons Morris III, Walnut Creek, CA (US)

(72) Inventor: Langdon Emmons Morris III, Walnut Creek, CA (US)

(21) Appl. No.: 13/750,203

(22) Filed: Jan. 25, 2013

(51) Int. Cl. G06Q 10/10

(52) U.S. Cl. CPC G06Q 10/101
USPC 705/300

(57) ABSTRACT

Embodiments of the invention may provide a software system for managing innovation. The system may be used by managers in organizations to guide and monitor the innovation process and to manage innovation projects. The system may comprise major elements, namely strategy system, portfolio system, process system, culture system and infrastructure system. Information prepared in each system may automatically populate the other systems. Strategy system tools may be employed for strategic planning. Portfolio System may track the innovation projects and investment and may be sorted by risk/reward level. Further, process system may collect ideas from users of the system. Furthermore, culture system may include role definitions and checklists for Leaders, Champions, and Geniuses and may aggregate information from all systems. The infrastructure system may include tutorials for users. Further, information from all the major elements may be accessible via a dashboard system.

### CROSS-REFERENCE TO RELATED APPLICATIONS

This application claims the benefit of the U.S. Provisional Patent Application No. 61/591,489 filed Jan. 27, 2012 by the present inventor. This provisional patent application is incorporated herein by reference.

### BACKGROUND OF THE INVENTION

Innovation management is an important topic for all organizations and government agencies because their capacity to innovate is central to their medium and long term survival. However, innovation management is a difficult field, as measurement of innovation processes is not well understood, the process of invention is complex and ephemeral, innovation investment is inherently risky, and it is generally unlike other types of management techniques and processes that executives are more familiar with. Given the acceleration of change and the rapid emergence of new technologies in this field, the field of innovation is considerably different today than it was 20 or 30 years ago.

Computer software can support many of the critical functions of innovation management. However, the present invention does so in a new, unique and comprehensive way.

There are many software tools that purport to be useful for innovation management, but most of the software tools are mainly idea collection and idea management tools. There does not exist currently in the market a comprehensive software system for the complete lifecycle of innovation.

Generally, there exists confusion between “idea management” and “innovation management”. However, the two are significantly different. “Idea management” is focused on gathering ideas from people as inputs to the innovation process, but this is only a small portion of what innovation management really needs to be. Existing software systems do idea management but not innovation management.

Effective innovation management requires an orderly combination of several complex processes: these include defining the strategic imperatives and priorities for a firm, improving the ideation and collaboration process, analyzing ideation in conjunction with strategic priorities for selection of an optimal innovation investment portfolio that increases the overall return on innovation investment, methods for evaluating potential future value from ideas that have not yet been proven, and integrated learning for team members that is adaptive to the actual innovation requirements of their organizations and the learning styles of participants. Of these processes, the most challenging is the process of analyzing new ideas with the goal of assessing their future value, and then designing a balanced investment portfolio that optimizes the process of translating sets of innovative ideas into strategic solutions that will return value to the organization in a variety of possible future market conditions. Optimization means reducing risk while simultaneously increasing returns on investment in a manner that maximizes the overall, long term utility function for an organization. Furthermore, innovation management involves collecting and managing ideas and refining and improving them through a disciplined innovation development process. No existing innovation management software performs these functions, and the information provided by the existing systems is incomplete or fragmented, which prevents managers from having a complete view of innovation efforts in their organizations.

Furthermore, there is not a comprehensive or systemic approach to innovation management underlying the existing software systems although innovation management is a complex task that is best accomplished via a comprehensive system. We call the comprehensive system described here the “innovation master plan”. The innovation master plan is a systematic approach that addresses the innovation management requirements of organizations by linking together in an effective way the five critical dimensions of innovation management, beginning with organizational strategy, which is defining the goals and targets for innovation projects, innovation investment strategy through the valuation of new ideas and the definition and management of the innovation portfolio, innovation process management through rigorous management of the linked processes of research, development, and marketing, innovation culture management to align the people in the organization to support and participate in the innovation process, and innovation infrastructure management to assure that the correct tools and methods are being applied throughout all aspects of the innovation endeavor.

Therefore, there exists a need to introduce a method and apparatus for a computer software system for comprehensive innovation management based on the innovation master plan framework.

### SUMMARY OF INVENTION

The present invention may be a software system for managing innovation. It may be used by managers in companies and in government agencies to gather new ideas for potential innovations, to help manage and monitor innovation projects as investments, to help manage and monitor the progress of innovation projects themselves.

Further, the present invention may disclose a system which may be based on a structured and defined methodology of innovation management that may further give guidance to a process that can otherwise be very vague and unmanageable.

For the purposes of describing the present invention, it is helpful to make the distinction between three types of users, “innovation leaders,” “innovation champions,” and “innovators” (or “creative geniuses”). An innovation leader may be a person who may be responsible for overseeing, controlling, directing, and leading an organization. An innovation champion may be a person who may be responsible for managing innovation portfolios and projects. An innovator may be a person who may contribute concepts and ideas that have innovative qualities, and also may perform specific tasks required to transform ideas into usable products and services. Such tasks may include financial analysis, competitive analysis, customer needs analysis, product design, services design, business model design, engineering, etc. The reason for making this distinction is that leaders, champions, and innovators require different types of information, and the computer software system for innovation management must meet the information needs of all three. Leaders may require comprehensive information about the business processes they are responsible for, and the present invention may provide them with complete information, while managers and innovators may require information about the ideas and concepts of others, which they may suggest improvements upon, or which they may use to develop their own new ideas, as one new idea often stimulates others.

Further, in an embodiment of the invention, the proposed system may provide guidance to users to help them develop the insights required to transform an idea into a completed innovation. The system may comprise an online tutorial to help them work effectively. Further, the system may define roles and responsibilities so users know where to get guidance and where to find answers to key questions. Furthermore, the system may prompt users with questions to help them improve the quality of their work.

In an embodiment of the present invention, the system may comprise a dashboard that may present the status of every innovation project, with multiple views available depending on the needs of the user. The system can be used on computers, touch screen tablets, smart phones, and in war rooms and meeting spaces. Further, system may apply a simple graphical user interface that is attractive and easy to use.

### BRIEF DESCRIPTION OF DRAWINGS

FIG. 1 illustrates a computer software system for managing processes, such as for innovation management, in accordance with an embodiment of the invention;

FIG. 2 illustrates a data model of a database residing on a server, such as the idea database 102a, in accordance with an embodiment of the invention;

FIG. 3 illustrates a data model of a database residing on a server, such as the people database 102b, in accordance with an embodiment of the invention;

FIG. 4 illustrates a data model of a database residing on a server, such as a workflow data model 400 of the workflow database 102c, in accordance with an embodiment of the invention;

FIG. 5 illustrates a software system of the preferred embodiment of the present invention;

FIG. 6 illustrates a screenshot of an “overview assessment” worksheet of the preferred embodiment of the present invention;

FIG. 7 illustrates a screenshot of an “exponential change” worksheet of the preferred embodiment of the present invention;

FIG. 8 illustrates a screenshot of a “the change curve” worksheet of the preferred embodiment of the present invention;

FIG. 9 illustrates screenshot of a “what is your strategy for dealing with the digital world” worksheet of the preferred embodiment of the present invention;

FIG. 10 illustrates screenshot of a “what is your strategy for dealing with exponential change” worksheet of the preferred embodiment of the present invention;

FIG. 11 illustrates a screenshot of a “what is your strategy for dealing with the globalization” worksheet of the preferred embodiment of the present invention;

FIG. 12 illustrates a screenshot of a “what is your strategy for dealing with the commoditization” worksheet of the preferred embodiment of the present invention;

FIG. 13 illustrates a screenshot of a “your ideal innovation portfolio” worksheet of the preferred embodiment of the present invention;

FIG. 14 illustrates a screenshot of a “strategic opportunities portfolio evaluation” worksheet of the preferred embodiment of the present invention;

FIG. 15 illustrates a screenshot of an “innovation portfolio evaluation” worksheet of the preferred embodiment of the present invention;

FIG. 16 illustrates a screenshot of a “workshop action plan” worksheet of the preferred embodiment of the present invention;

FIG. 17 illustrates a screenshot of a “4 innovation drivers” worksheet of the preferred embodiment of the present invention;

FIG. 18 illustrates a screenshot of an “innovation self-evaluation questionnaire” worksheet of the preferred embodiment of the present invention;

FIG. 19 illustrates a screenshot of an “innovation self-evaluation” worksheet of the preferred embodiment of the present invention;

FIG. 20 illustrates a screenshot of a “self-evaluation instructions” worksheet of the preferred embodiment of the present invention;

FIG. 21 illustrates a screenshot of a “3 questions” worksheet of the preferred embodiment of the present invention;

FIG. 22 illustrates a screenshot of an “innovation infrastructure assessment” worksheet of the preferred embodiment of the present invention; and

FIG. 23 illustrates a screenshot of training modules showing video teaching tools.

For purposes of clarity and brevity, like elements and components may bear the same designations and numbering throughout the FIGS.

### DETAILED DESCRIPTION OF INVENTION

This patent describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

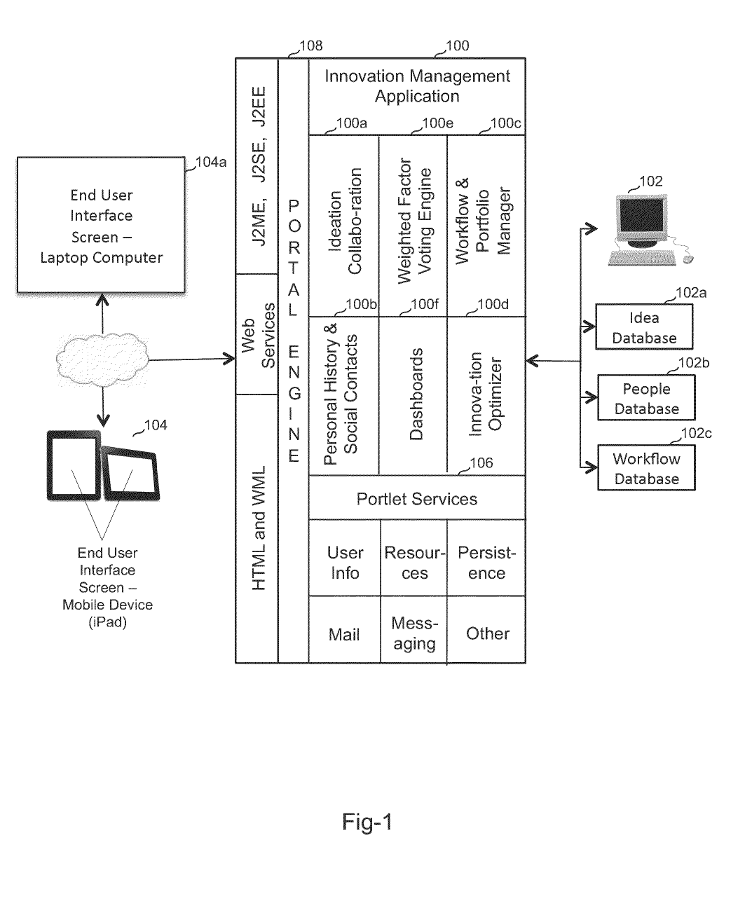

FIG. 1 illustrates a computer software system for managing processes, such as for innovation management, in accordance with an embodiment of the invention. A system 100 may reside on an administrative server 102. Hereinafter, the administrative server 102 may be referred to as ‘admin’. Further, the system 100 may apply a graphical user interface 104a which may be used by a user. Furthermore, the user may use the system 100 on a user's device 104. In an embodiment, the user's device may be a computer, a smart phone, or a tablet. Hereinafter, a user and a user's device may be interchangeably used. Further, the system 100 may be provided to a client, where a user may apply a user interface on the user's device to use the system 100. A user using the user's device 104 may interact with the system 100 through a web portal engine 108. Here, a client interacting with the system 100 may be a government organization or a company. Hereinafter, the government organization or a company may be referred to as an organization. In another embodiment, a user may be a manager or an innovator or a worker or an employee of the organization.

As mentioned above, the system 100 may reside on the administrative server 102, where the administrative server 102 may be able to monitor the system 100 for performance and quality of service provided to a client. Further, the administrative server 102 may be able to restart the system 100 to recover availability, and provide orderly reset to prior versions. Furthermore, the system 100 may provide a complete audit trail of messaging, and eventually, transactions for client/customer service. Also, the system 100 may log all events in verbose mode during the burn-in period and to provide assistance in debugging. Further, all functions may be available through administrative server 102, including backup, orderly rollback, application staging, and message broadcast and logging regarding planned maintenance outages.

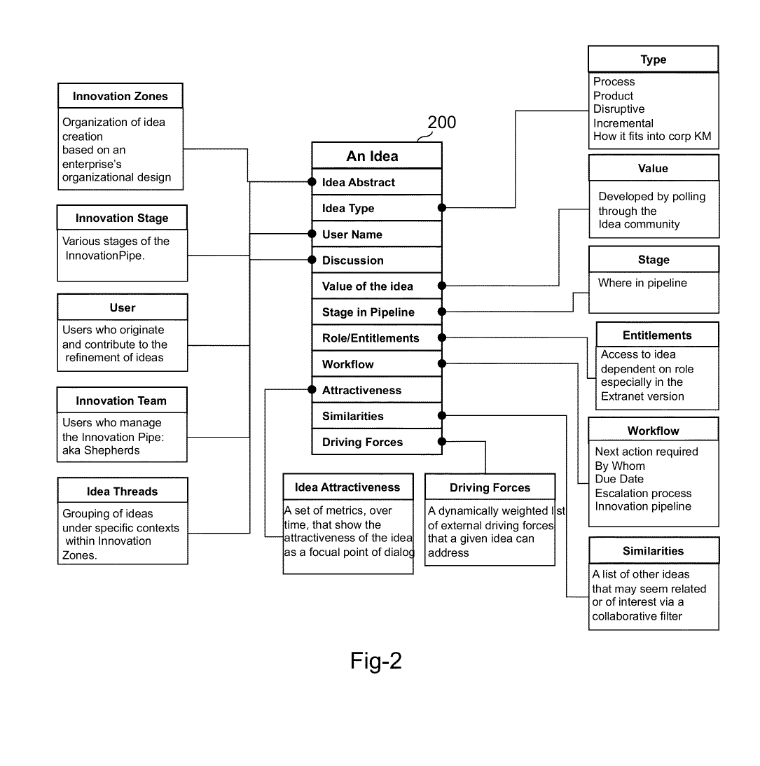

Further, the system 100 may reside on the administrative server 102 along with the databases, where the databases may be required by the system 100 to fetch necessary information. The administrative server 102 may comprise an idea database 102a, a people database 102b, and a workflow database 102c. The idea database 102a may include detailed data about different ideas innovating in an organization. The data model of the idea database 102a is further explained in detail in conjunction with FIG. 2.

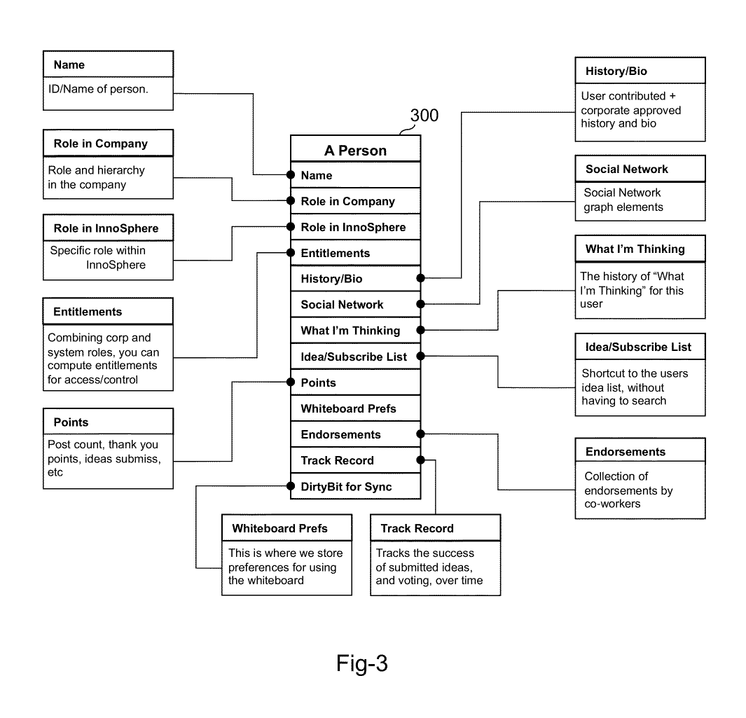

Furthermore, the people database 102b may include detailed information about a person in the organization. A person may be a leader, champion, innovator, a worker or any other employee in the organization using the system 100. The people database 102b may be discussed in detail in conjunction with FIG. 3.

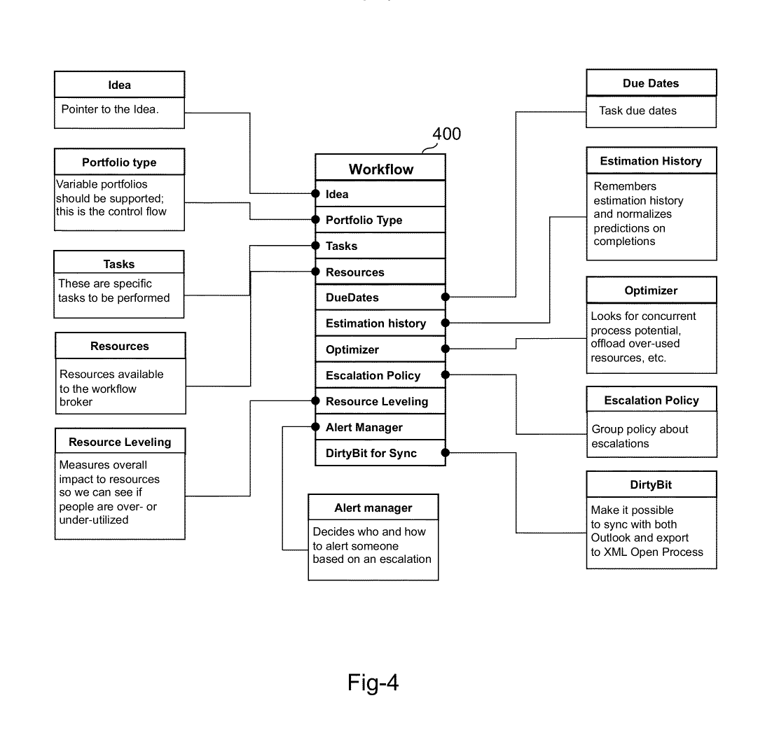

Additionally, the administrative server 102 may also include workflow database 102c. The workflow database 102c may include information regarding innovation projects running in the organization. The data may include information and is not restricted to idea related to the project, important dates, resources, reporting manager and the like. The workflow database 102c may be discussed in detail in conjunction with FIG. 4.

As shown in FIG. 1, the system 100 may reside on the administrative server 102 along with necessary databases, and may also be communicated to a user's device 104 for installing and using the system 100 in the user's organization. The system 100 may include an ideation collaboration module 100a, a personal history and social contacts module 100b, a workflow and portfolio manager 100c, an innovation optimizer 100d, a weighted factor voting engine 100e and dashboards 100f. Further, the system 100 may comprise portlet services 106, where the portlet services 106 may include and are not restricted to user info, mail, resources, messaging, persistence and other kind of portlet services. Furthermore, the system 100 may comprise a web portal engine 108, where the web portal engine 108 may help a user using the user's device 104 in getting connected to the system 100. Hence, the user's device 104 may interact with the system 100 through a web portal engine, where the web portal engine 108 may include web services, languages, and servlets.

The system 100 may include an ideation collaboration module 100a. The ideation collaboration module 100a may be involved in ideation process including idea generation, collection, and development. The ideation collaboration module 100a may keep a record of innovative ideas generated in the organization. The innovative ideas may be generated via different workshops, brainstorming activities, and the like among the users in the organization. These innovations may be recorded utilizing the ideation collaboration module 100a. Further, the ideation collaboration module 100a may collect or collaborate these ideas. Thereafter, an ideation collaboration module 100a may help in developing, expanding, funneling the ideas from most important to least or vice versa, then testing and applying the ideas. Additionally, the ideation collaboration module 100a may also filter the ideas based on a deciding factor. The factor may be risks or rewards level, or the priority to the organization, and the like. The ideation collaboration module 100a of the system 100 may communicate with the idea database 102a to fetch idea data from it.

Further, the system 100 may include personal history and social contacts module 100b. Since innovation has always required those with different skills and expertise to come together and create, therefore, innovation has always been a social process. Globalization ensures expertise exists in every corner of the world. Therefore, the personal history and social contacts module 100b may help create valid assessments of proposed ideas by taking into account the past performance of the person or persons proposing an idea, the past performance of those voting for an idea, and the quality of the network of contacts of both, where the assessment (A) is a function of the past idea success (Pᵢ), the past voting success (Pᵥ), and the quality of prior voting opinions (Qₚ), which may be shown as A=f(Pᵢ, Pᵥ, Qₚ). The personal history and social contacts module 100b may fetch employee details from the people database 102b.

Furthermore, the system 100 may also include a workflow and portfolio manager 100c. The workflow and portfolio manager 100c may help in overseeing innovation projects running in the organization. This workflow and portfolio manager 100c may help in keeping a check on the details of an innovation project, for example the workflow and portfolio manager 100c may keep a check on the resources used and to be used in the project, may record all the important dates of the project, such as starting and ending dates, may also keep a record of the details of employees involved in the project. Further, the workflow and portfolio manager 100c may set a portfolio type, where a control flow for a project may be decided.

The workflow and portfolio manager may include proprietary Strategic Value Calculation (SVC) algorithms to help innovation leaders and champions to dynamically determine the potential future value of innovation projects by providing them with insight into the relative merits of such projects and projects collected as portfolios. Such an algorithm might be a method of calculating the potential strategic value of an innovation project or portfolio of projects, such as V=f(Cₚ, Cₛ, R_{c}, Cₜ, Cₘ, Cₐ), where the figures in the numerator represent external factors, which, as they tend to greater complexity thereby increase uncertainty and therefore risk, and the figures in the denominator represent internal factors that reduce or mitigate risk, and where V represents the expected Value created as a function of the following variables, Cₚ representing a numerical value for the Complexity of the product or service under consideration, Cₛ representing a numerical value for the Complexity of the Supply Chain supporting that product or service, R_{c} representing a numerical value for the Rate of Change in the pertinent industry, Cᵣ representing a numerical value for Technical Capability of the producing organization, Cₘ representing a numerical value for Capability of Manufacturing and agility to apply new technologies and methods, and Cₐ representing Customer Awareness indicating the degree of awareness of the intended customer's explicit and tacit requirements. Use of such an algorithm on a consistent basis across many projects may provide portfolio managers with an improved ability to evaluate the likely future value of their innovation projects and to help them make better investment decisions.

Determining the definitive values of these individual variables is not as important as their impact on value and is often non-linear and depends heavily on the content, industry, situation, etc. The system may provide sliders to allow users to increase and decrease these values, and immediately see, in real-time, the general effect on value they may have. The workflow and portfolio manager may dynamically recalculate the values for individual projects and projects collected as portfolios based on data input by innovation leaders concerning any of the algorithm variables, which may occur as a result of strategically significant changes in the external, market environment or due to internal changes in the organization. Such recalculation may assist leaders and champions in making management decisions and investment decisions to thereby improve the likelihood of success for innovation projects that are otherwise more uncertain and more difficult to manage.

The workflow and portfolio manager may fetch the details of the projects from the workflow database 102c.

As shown in the FIG. 1, the system 100 may include an innovation optimizer 100d. The innovation optimizer 100d may help in optimizing the innovation process by keeping a check on several features of the project affecting the project. The innovation optimizer 100d may look for concurrent process potential. Also, the innovation optimizer 100d may look for offload over-used resources to optimize the quantity of the resources used in the innovation projects. Further, the innovation optimizer 100d may fetch the project details from the workflow database 102c.

Further, the system 100 may include a Weighted Factor Voting Engine 100e which may enable users to conduct evaluations of proposed and existing innovation projects and to assess the relative significance of the various evaluation criteria being used, and to adjust the weighting of the criteria dynamically to better assess the impact of potential changes to various external conditions.

Furthermore, the system 100 may include dashboards 100f. The users may access the system 100 through dashboards. The dashboards 100f may present the status of every innovation project, with multiple views depending on needs of user. The dashboards 100f may also aggregate data on multiple projects for viewing as sets of related projects and ideas. The dashboards may also support dynamic recalculation for modeling purposes by providing sliders for critical variables that users may adjust in order to assess the potential performance of a portfolio in a variety of external and internal performance situations.

As mentioned above, the system 100 may comprise portlet services 106. The portlet services 106 may include and are not restricted to user info, mail, messaging, resources, persistence and other. The user info may include information of the user using the system 100, such as the user's name, designation, department, social network and the like. Further, the portlet services 106 may include mail and messaging to provide mailing and messaging services to the users. Other portlet services may include and are not restricted to blogs, forums, chat, video conferencing and the like.

FIG. 2 illustrates a data model of a database residing on a server, such as the idea database 102a, in accordance with an embodiment of the invention. The idea database 102a may communicate with the system 100, and may provide important details regarding innovation ideas to the system 100. The ideation collaboration module 100a of the system 100 may utilize these details of the ideas. Idea collaboration may include an algorithm that ranks the probable quality (Q) of an idea as a function of reputation of the person proposing the idea (Rₚ), the reputation of the people who vote for the idea (Rᵥ), in conjunction with the ranking of the idea according to the Strategic Value Calculation (SVC), where Q=f(Rₚ, Rᵥ, SVC). Ranking may be dynamically adjusted as additional people vote for an idea and their own reputation ranking affects the probable Q rating. Ranking may also be dynamically adjusted as the SVC value changes due to changes in external conditions or to changes in the organization's strategic priorities.

According to the FIG. 2, the idea data model 200 may include data and is not restricted to idea abstract, idea type, user name, discussion, value of the idea, stage in portfolio, role/entitlements, workflow, attractiveness, similarities and the like. Idea abstract data may provide information about the innovation zone and innovation stage of the idea. Innovation zone may define organization of idea creation based on an enterprise's organizational design, whereas the innovation stage may define various stages of Innovation Portfolio. Further, the idea type may describe information regarding the type of process, product, disruptive, incremental, and the like. Furthermore, the idea data model 200 may describe users who originate and contribute to the refinement of ideas and users' information who manage the Innovation Portfolio, under user name data.

Also, the idea data model 200 may group ideas under specific contexts within Innovation Zones, under discussion data. Further, a value of the idea may be developed by polling through the Idea community. The stage of the idea in its portfolio may also be shown by the idea data model 200. It may also be described here that which user/employee may have access to idea, depending on role especially in the extranet version, under roles/entitlement. Further, a workflow process may also be disclosed in the idea data model 200, where the workflow process may include information, such as, next action required by whom, Due Date, Escalation process, Innovation portfolio and the like. Furthermore, velocities and similarities may also be defined, where a set of metrics, over time that show the attractiveness and breadth of discussion may be defined under velocity and a list of other ideas that may seem related or of interest via a collaborative filter may be defined under similarities, by the idea data model 200.

FIG. 3 illustrates a data model of a database residing on a server, such as the people database 102b, in accordance with an embodiment of the invention. The people data model 300 may define information related to a user in an organization, who is interacting with the system 100. The people data model 300 may include data and is not restricted to name, role in the company, role in innovation community, entitlements, history/bio, social network, what I am thinking, idea/subscribe list, points, whiteboards preferences, endorsements, and track record and the like.

The people data model may define the ID/name of the person, role in the company, user's contribution, social network graph elements, track records of the user, shortcut to the user's idea list, endorsements and other information related to the users in the organization. The personal history and social contacts module 100b of the system 100 may fetch details from the people database 102b, where the data is organized in people data model 300 structure.

FIG. 4 illustrates a data model of a database residing on a server, such as a workflow data model 400 of the workflow database 102c, in accordance with an embodiment of the invention. The workflow data model 400 may include information related to the workflow of the innovation projects running in the organization. The system 100 may fetch information related to the projects from the workflow data model 400 to keep a check on the ongoing projects. The workflow data model may include data and is not restricted to idea, portfolio type, tasks, resources, due dates, estimation history, optimizer, escalation policy, resource leveling, alert manager, DirtyBit for Sync, and the like.

The workflow data model 400 may point to a particular idea stored in the idea database 102a. Further, the workflow data model 400 may define variable portfolios of innovation projects, describing the control flow. Further, the workflow data model 400 may also define the quantity of the resources available to the broker, tasks to be performed in the portfolio, due dates of the project, a manager for alerting during a project portfolio based on escalation, and other related information to the workflow.

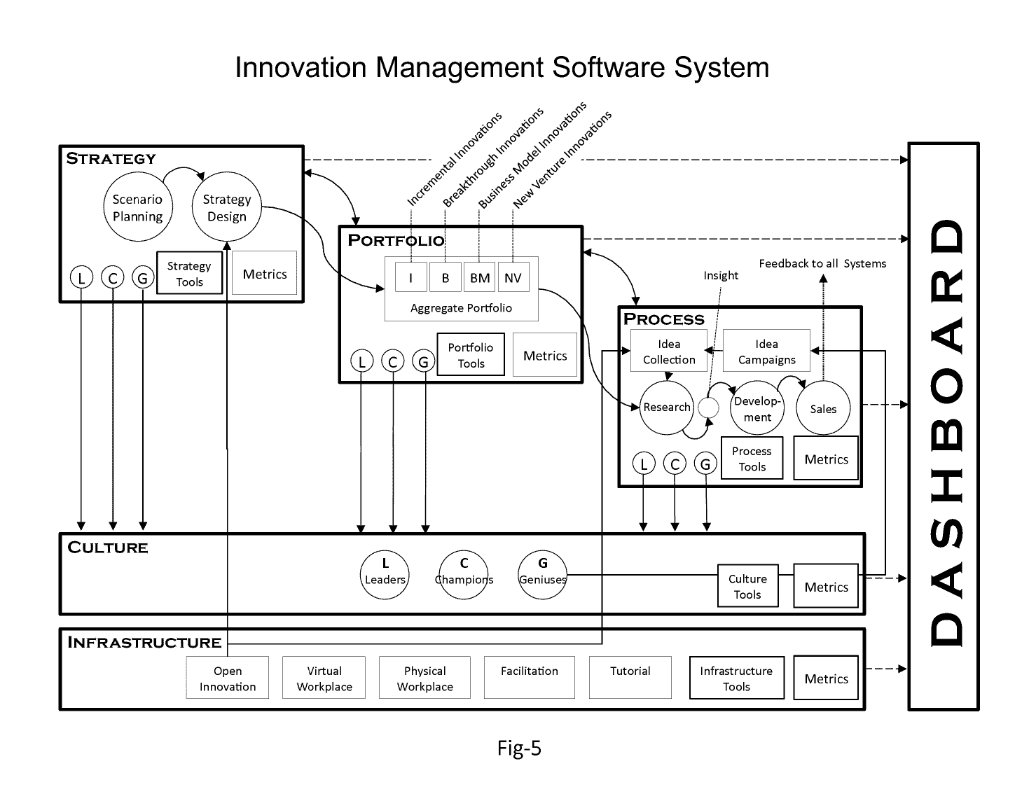

FIG. 5 illustrates a computer software system used for managing processes, such as innovation, in an organization, in accordance with the preferred embodiment of the present invention. The present invention may describe a software system for managing innovation in an organization, such as government agencies or private companies. Hereinafter, the private companies and government agencies may be collectively termed as ‘organization’. Further, the proposed computer software system, hereinafter referred as ‘system’, may be used by various users in the private companies (and/or government organizations) to monitor the innovation processes, and also to monitor specific innovation projects that are under way. In an embodiment of the invention, the users of the proposed system may be a leader of the organization. In another embodiment of the invention, the users of the proposed system may be a champion (or manager) of the organization. In a yet another embodiment of the invention, the user of the proposed system may be a worker, or genius, of the organization. In a further embodiment of the invention, the users of the proposed system may be any employee of the organization. Therefore, the present invention may disclose a computer software system for innovation management for enabling everyone to better participate in the innovation process in the organization.

According to an embodiment of the invention, FIG. 5 illustrates the system 100 for innovation management, where the system may comprise five major elements, namely; Strategy system 502, Portfolio system 504, Process system 506, Culture system 508, and Infrastructure system 510. The system 100 further may comprise a dashboard 512 with which all the above mentioned elements may be communicating or connected with in the system 100.

Further, the strategy system 502 may comprise tools that may assist or enable users to think through the complex issues pertinent to an organization's strategy for the future. It may consist of a scenario planning module 502a, a strategy design module 502b, as well as specific metrics and tools defined for the strategy system 502. Further, the strategy system 502 may include specific roles definitions for Leaders, Champions, and Geniuses, which may be further linked to the Culture system 508 where information on Leaders, Champions, and Geniuses may be aggregated.

The strategy system 502 may be a series of tools in the form of worksheets and templates that may further enable the user to organize a strategy design process, by utilizing strategy design module 502b. Information prepared in this system 502 may automatically populate the other elements, namely portfolio system 504, process system 506, culture system 508 and infrastructure system 510.

The scenario planning module may consist of tools that enable users to consider a wide range of possible future scenarios, which may include an inventory of factors such as the rate of change, best and worst-case scenarios of future conditions, possible initiatives undertaken by competitors, all of which may be useful in creating a clearer picture of the future and in determining where the organization should direct its innovation investments.

The scenario planning module may include a Dynamically Weighted Driving Forces Inventory, which may be created automatically in the system as an aggregate of prior work. Such an inventory may be useful as a method of determining which ideas may be more valuable in the future. Such inventory may automatically update the Idea database shown in FIG. 2.

Further, the strategy system 502 may comprise the below mentioned component worksheets and templates.

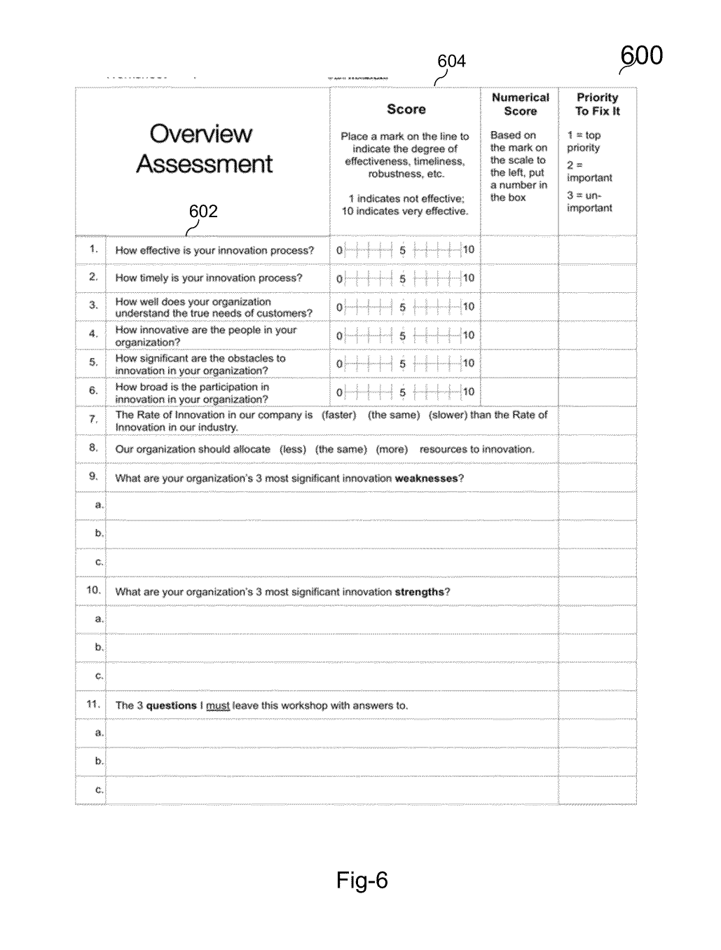

A strategy system component, named as overview assessment worksheet 600, for assessing overview, as shown in FIG. 6. The overview assessment worksheet 600 may include rows 602 and columns 604, where the rows 602 may include questions or advice in rows 602a, 602b, and so on until 602k, whereas, the columns 604 may include ratings or answers to the questions. Further, the overview assessment worksheet 600 may be filled in by the users of the organizations to assess the overview. A collective overview assessment from the required number users of the organization may help in providing a strategic approach and guidance to the innovation management.

In an embodiment of the invention, the overview assessment worksheet 600 may include questions, such as, ‘how effective is your innovation process?’, ‘how timely is your innovation process?’, ‘how innovative are the people in your organization?’ etc. Further, in an embodiment, the overview assessment worksheet 600 may include ratings for rate of innovation in the organization, resources for innovation, etc.

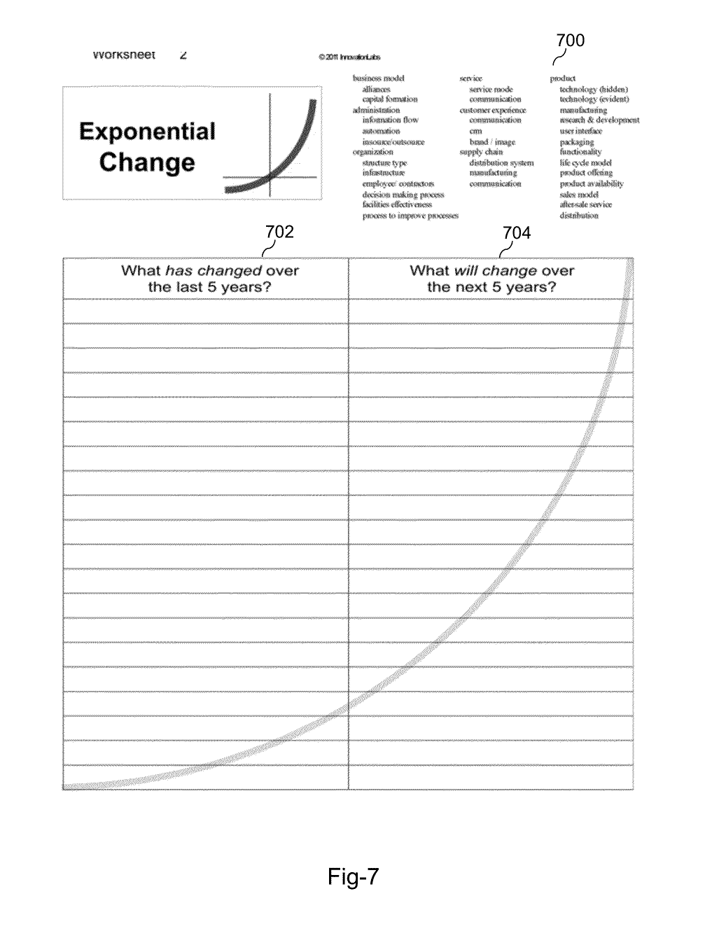

Further, a strategy component, named the exponential change worksheet 700, for assessing exponential change, as shown in FIG. 7, may be comprised as a worksheet in strategy system 502. The exponential change worksheet 700 may include columns 702 and 704, where column 702 may include a question for the change that has occurred over a period of time in the organization. Whereas, column 704 may include a question regarding future change in the organization over a period of time. In an embodiment, the time period for the explaining the changes in the exponential change worksheet 700 may be 5 years.

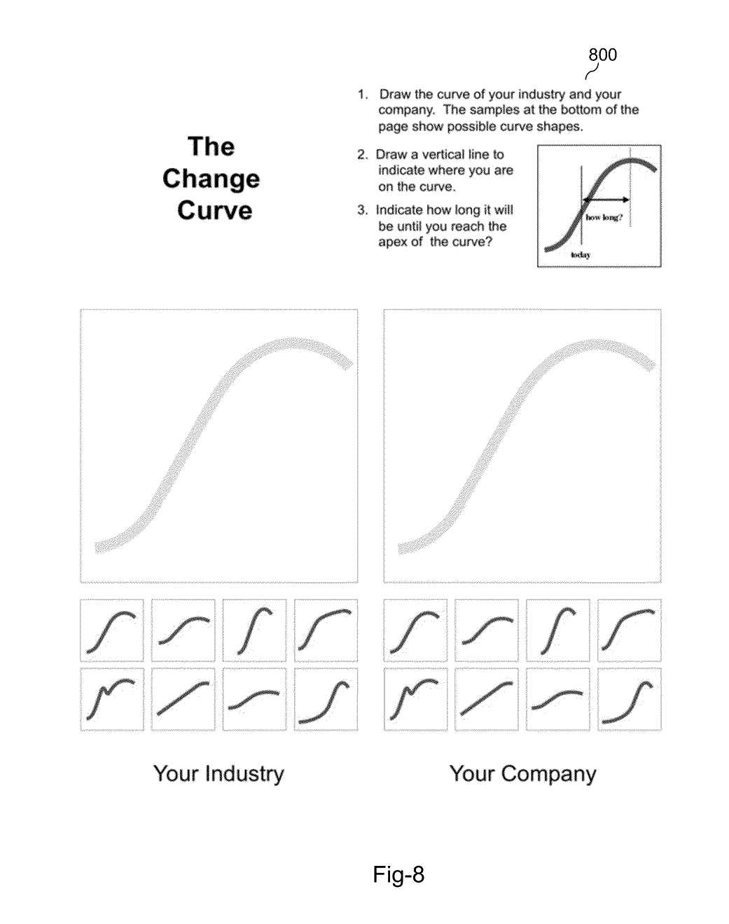

Furthermore, FIG. 8 shows a strategy component, named the change curve worksheet 800, for assessing change and determining the types of innovation that may be most valuable to the organization at a given time. In an embodiment, the change curve worksheet 800 may be filled by the users, where the change curve worksheet 800 may ask the users to draw change curves indicating their organization's curve and industry's curves. Additionally, the change curve worksheet 800 may also ask the users to indicate their organization's position on the drawn curve and to indicate the time period taken by them to reach the apex of the curve. Assessing these change curve worksheets 800 collectively from all the users may help in defining a future strategy for the organization by helping the innovation managers in the organization to identify the proper or necessary type or types of innovation in which it may be productive or necessary to invest, in that different types of innovation can be strategically important to a given organization depending upon their current position on the change curve. During a time of slow and steady company or industry growth, a greater proportion of innovation effort can be in incremental innovation, but when an organization is near, at, or past the peak of the curve then incremental innovation is not likely to be strategically significant, and breakthrough or business model innovations are called for. Further, the change curve worksheets 800 may also show a comparison between the respective organization and the whole industry related to that organization, which would also help to identify the best types of innovation targets.

Data collected through the use of change curve worksheets 800 may be dynamically populated to the portfolio system 504 as a weighting to innovation evaluation criteria pertinent to Idea Type as shown in FIG. 2.

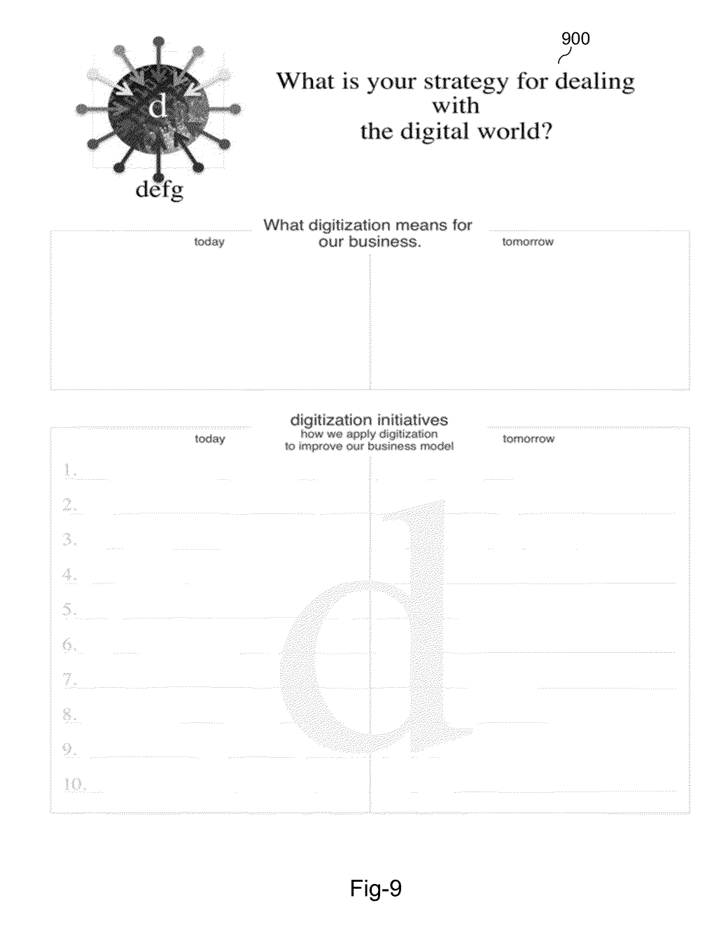

Another strategy component, named the strategy/digital world worksheet 900, for assessing digitization, is shown in FIG. 9. The strategy/digital world worksheet 900 may help in incorporating principles and products related to digitization into business model of the organization. In an embodiment of the invention, the strategy/digital world worksheet 900 may include views from the users on digitization regarding respective business models of the organization, and further, suggest how digitization might improve the outcomes of the business models and provide suitable innovation targets. Data collected through the use of strategy/digital world worksheets 900 may be dynamically populated to the portfolio system 504 as a weighting to innovation evaluation criteria pertinent to Idea Type as shown in the Idea database, FIG. 2.

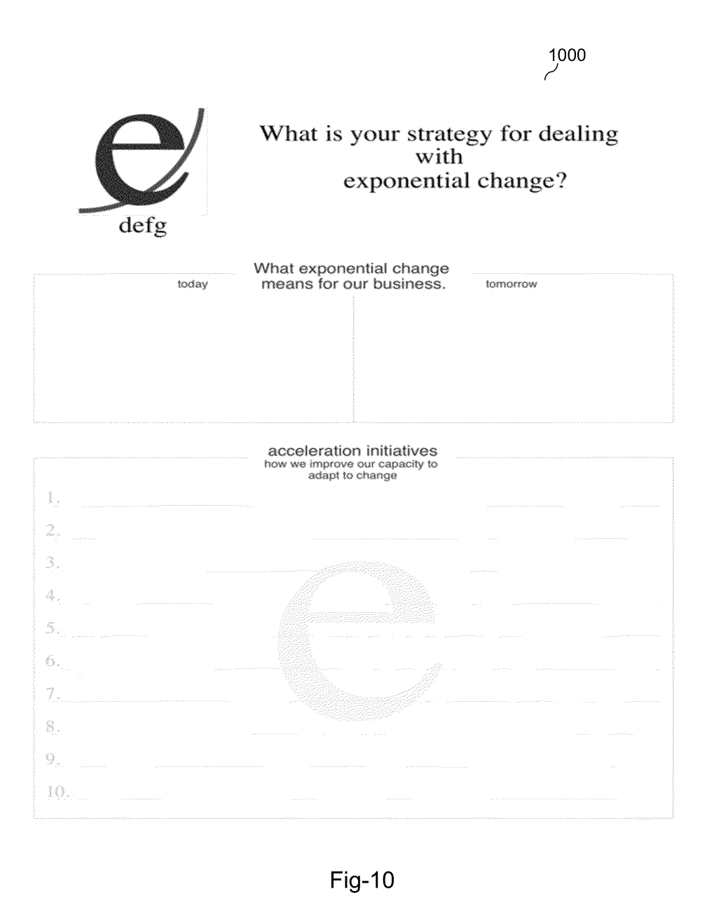

Another strategy component, named the strategy/exponential change worksheet 1000 for assessing exponential change is shown in FIG. 10. Again, in this strategy/exponential change worksheet 1000, views on exponential changes for business from the users of the organization may be taken. Further, in an embodiment, the strategy/exponential change worksheet 1000 may also include advice for improving the capacity of the organization to adapt to the exponential changes identified in this strategy/exponential change worksheet 1000.

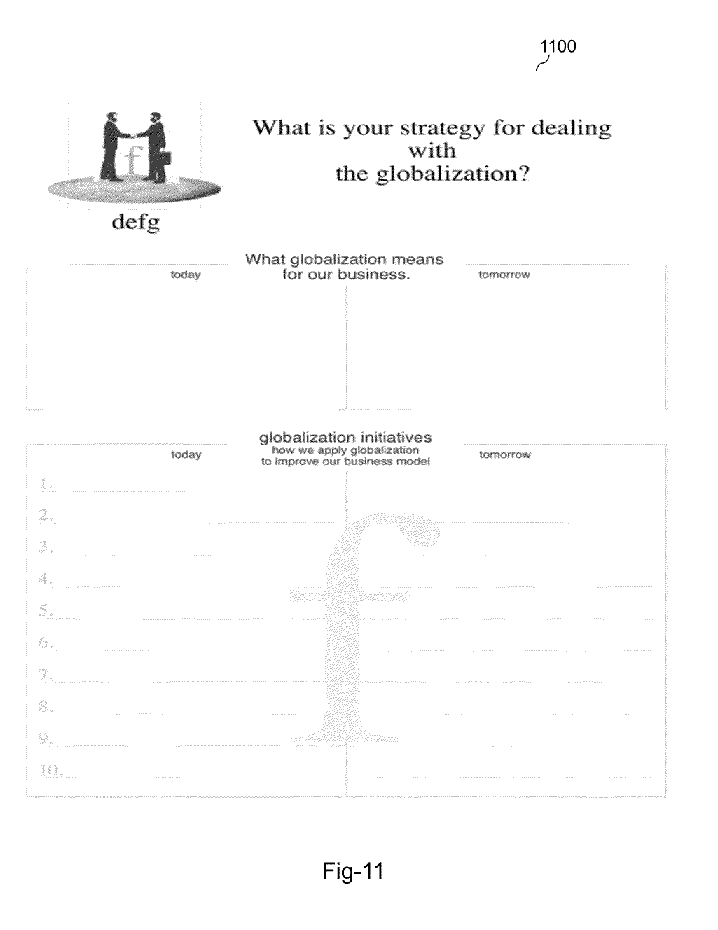

Another strategy component, named the strategy/globalization worksheet 1100, for assessing globalization, is illustrated in FIG. 11. Similarly as mentioned in FIGS. 9 and 10, the strategy/globalization worksheet 1100 may work in the similar manner regarding strategies to be followed for dealing with globalization, and identifying innovation targets pertinent to globalization opportunities.

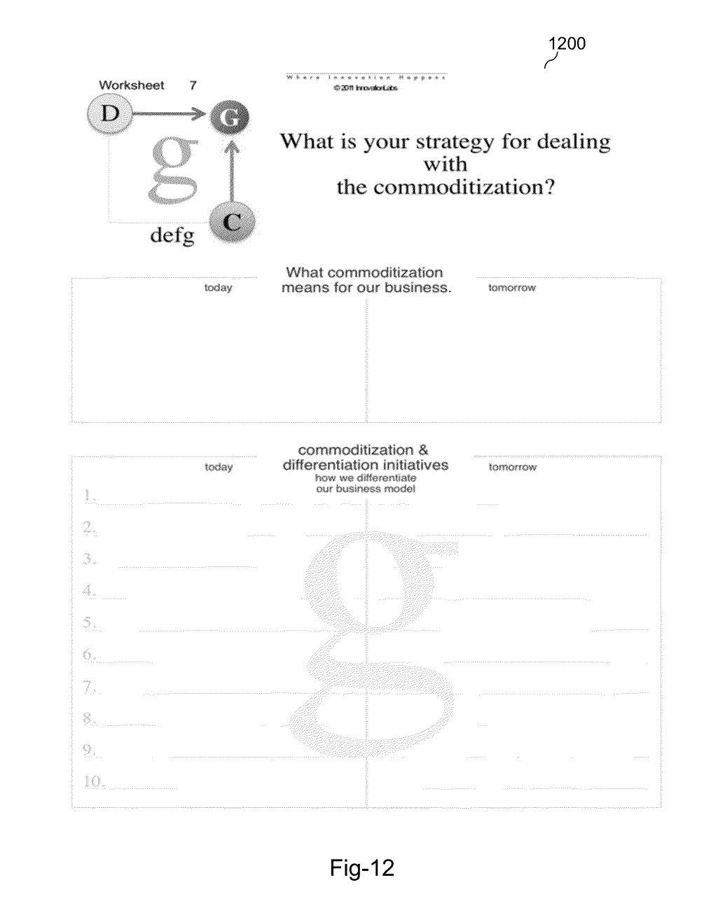

In the similar way, strategy/commoditization worksheet 1200, for assessing commoditization, as shown in FIG. 12 may gather views about strategies to deal with commoditization.

Hence, all the above mentioned strategy components may help in planning present and future scenarios of an organization, and further building up a strategy designed to fulfill the needs for innovation management in the organization, by utilizing the scenario planning module 502a and strategy design module 502b respectively.

Further, as shown in FIG. 5, the system 100 may also comprise another major element referred to as portfolio system 504. The portfolio system 504 may be a set of five portfolios, including Incremental Innovations 504a, Breakthrough Innovations 504b, Business Model Innovations 504c, and New Venture Innovations 504d, and an aggregate portfolio 504e of all of them.

Information or data gathered by the scenario planning module 502a may be fed to the strategy design module 502b in the strategy system 502 for preparing strategies to be followed for innovation management in the organization. Thereafter, the information collected in the strategy system 502 may be fed to the portfolio system 504 from the strategy design module 502b in the strategy system 502. Therefore, in the system 100, both the strategy system 502 and portfolio system 504 may be communicating with each other.

Further, each portfolio 504a-504d may track all individual projects in that category, as well as total investment in that category. Each portfolio may also be sorted by risk/reward level. The portfolio system 504 may further comprise specific metrics and tools defined for it. It may also comprise specific roles definitions for Leaders, Champions, and Geniuses, which may be linked to the Culture system 508 where information on Leaders, Champions, and Geniuses may be aggregated.

Furthermore, the portfolio system 504 may comprise following component worksheets and templates:

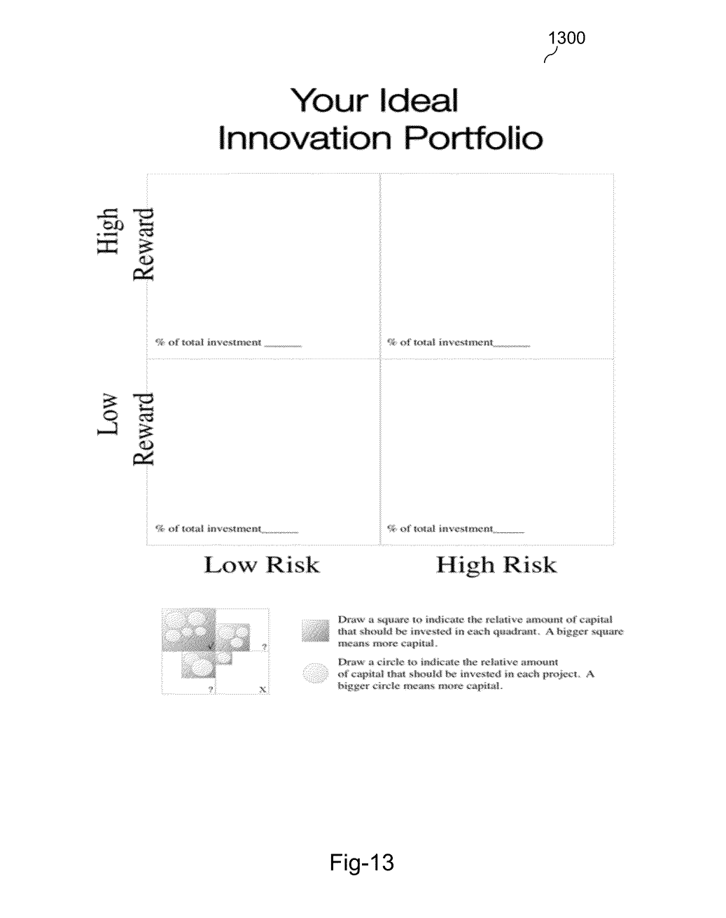

A portfolio system component, named the ideal innovation portfolio worksheet 1300, for plotting an innovation portfolio, is shown in the FIG. 13. The ideal innovation portfolio worksheet 1300 may indicate a relative amount of capital that may be estimated for investing in a project. In an embodiment, the ideal innovation portfolio worksheet 1300 may also indicate risk and reward level related to each project to be run in an organization.

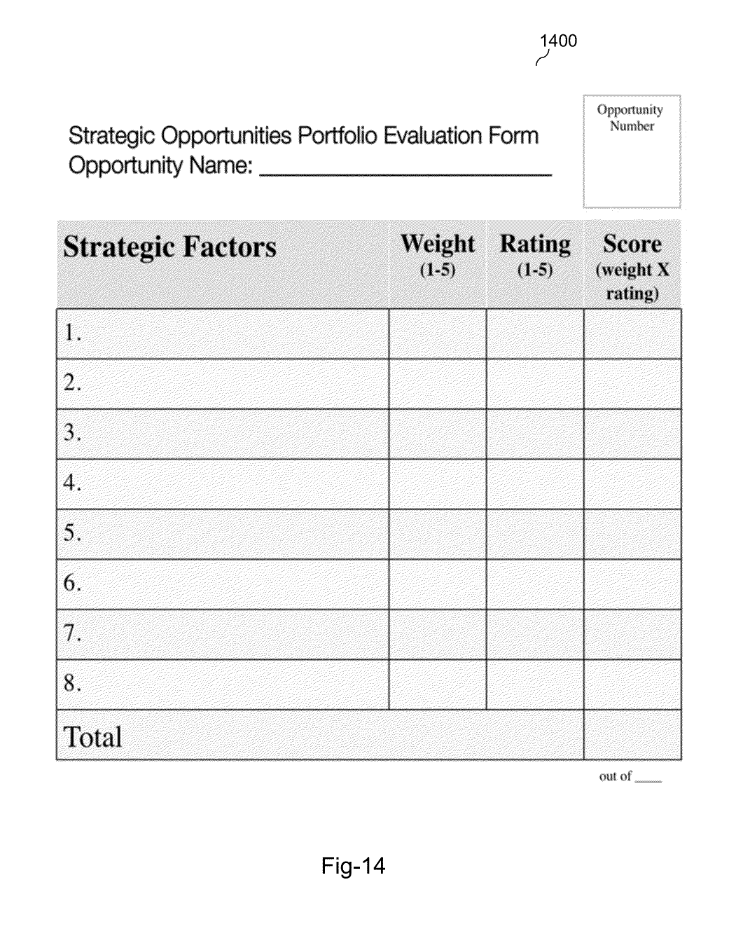

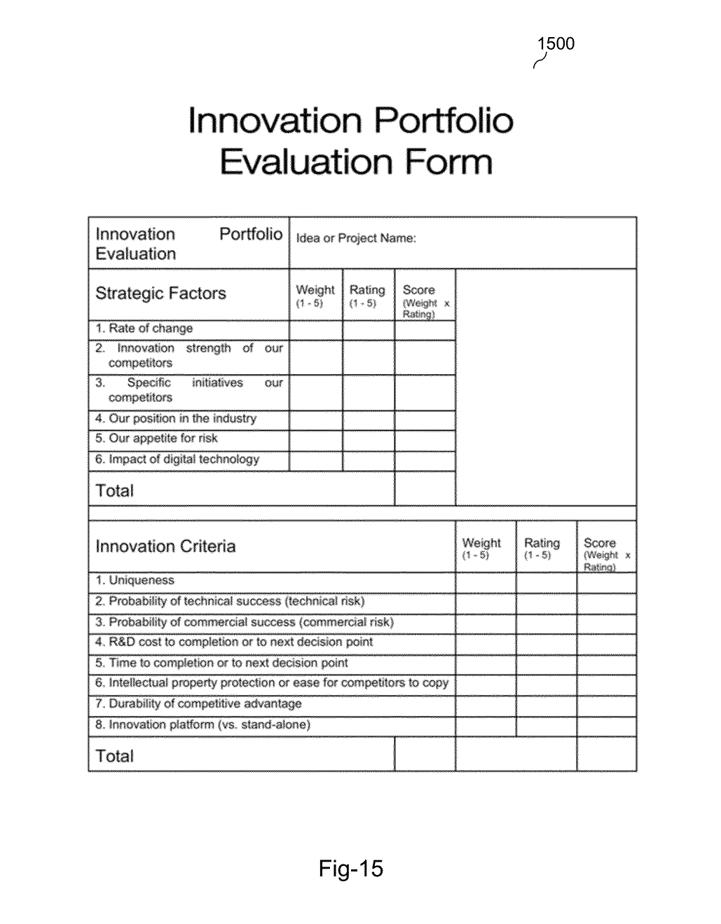

Another portfolio system component, named the strategic opportunities worksheet 1400 for ranking strategic factors is illustrated in the FIG. 14. Yet another portfolio system component, named the innovation portfolio evaluation form 1500 for evaluating a proposed innovation project shown in FIG. 15. The innovation portfolio evaluation form 1500 may help in evaluating a strength of an innovation project, by providing a scoring or ranking to several factors, such as rate of change, flexibility for risks in the organization, comparison to the industry, etc.

Further, the portfolio system components may be ‘innovation in your industry worksheet’ for assessing innovation within in an industry; ‘innovation table worksheet’ for categorizing types of innovation; ‘business model innovation attributes worksheet’ for identifying innovation attributes; ‘business model innovation examples’ for identifying internal innovation examples; and business model matrix worksheet for plotting business models compared with competition.

Additionally, the portfolio system 504 may have components including ‘reward/risk matrix worksheet’ for plotting reward and risk, and ‘4 types of innovation worksheet’ for ranking innovation methodologies.

Further, as shown in the FIG. 5, the portfolio system 504 may communicate with the process system 506 in the system 100. The information gathered in the portfolio system 504 by employing the above mentioned portfolio components, may be thereafter fed to the process system 506. More specifically, the information or data from the portfolio system 504 may be communicated to a research management system 506c in the process system 506.

The process system 506 may comprise an Idea Management system that further may comprise an Idea Collection Manager 506a and an Idea Campaigns Manager 506b. Furthermore, the process system 506 may also comprise a Research Management System 506c, an Insight Management System 506d, a Development Management System 506e, and a Sales Management System 506f. Additionally, the process system 506 may also comprise specific metrics and tools defined for the process system 506 only.

Further, the process system 506 may also include specific roles definitions for Leaders, Champions, and Geniuses, which may be linked to the Culture system 508 where information on Leaders, Champions, and Geniuses may be aggregated, similarly as were included in the strategy system 502 and portfolio system 504.

The process system 506 may possess following component worksheets and templates:

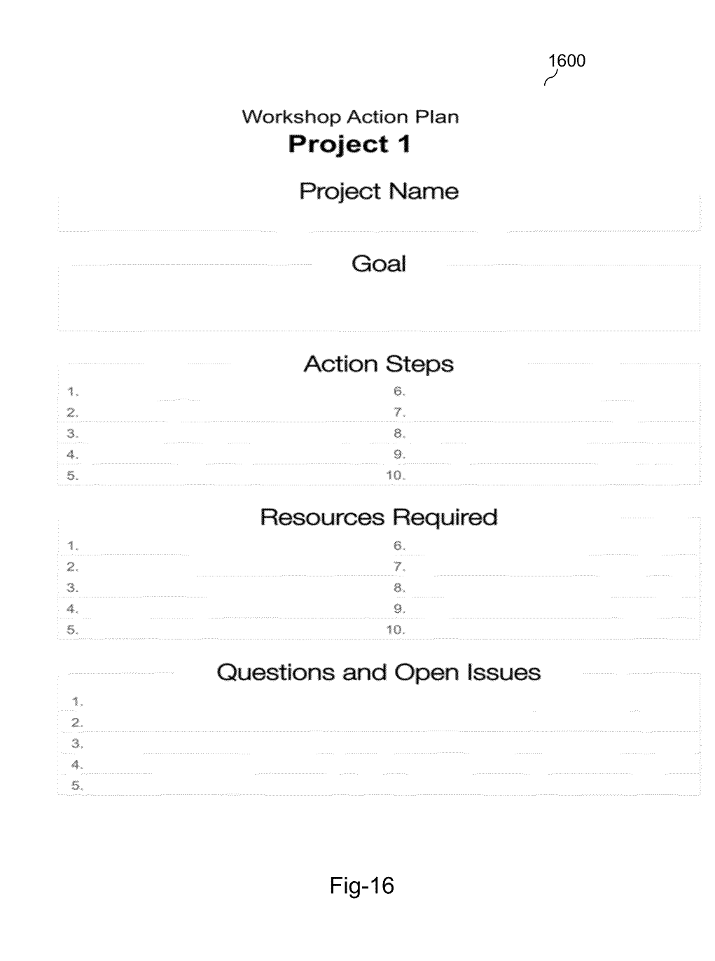

A process system component, the workshop action plan worksheet 1600, for outlining an action plan, is shown in FIG. 16. The workshop action plan worksheet 1600 may include the name of an innovation project, steps to be taken for the project, required resources, along with question and issues to be raised during the project.

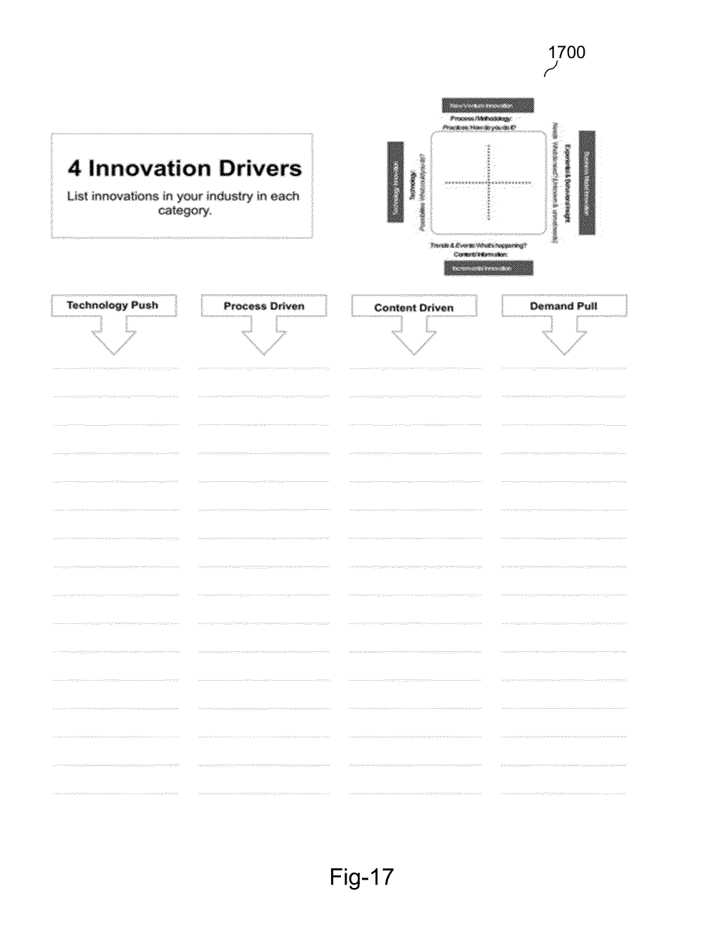

A process system component, the innovation drivers worksheet 1700, for plotting innovation drivers, is shown in FIG. 17. Another process system components may be—‘4 innovation drivers map a’ for plotting current innovation drivers, ‘4 innovation drivers—map b’ for plotting ideal innovation drivers, ‘analytical framework for innovation worksheet’ for assessing the innovation framework, ‘needfinding sources worksheet’ for identifying needfinding sources, ‘needfinding sources worksheet’ for identifying needfinding examples, and ‘ideation worksheet’ for collecting thoughts and comments.

Further, as shown in the FIG. 5, the culture system 508 may be linked with each of the strategy system 502, portfolio system 504 and process system 506. The culture system 508 may include specific roles definitions and checklists for Leaders, Champions, and Geniuses, and may aggregate information from all the other systems 502, 504 and 506. Culture may be the people part of innovation. The organizations may prefer to have their people developing and sharing new ideas, and also contributing to and improving ideas of others. In order for this to occur, the system 100 may define certain specific roles that are played in the organization, in the culture system 508.

The culture system 508 may define a Leader as an Innovation Leader, who may be a senior manager and has the authority to assign resources, to make policy, and to provide leadership so that specific tasks and jobs are accomplished in the organization. Further, the culture system 508 may define Geniuses as those people who come up with new ideas. Furthermore, the culture system 508 may also define champions as those people who manage specific aspects of the innovation process. Additionally, the culture system 508 may also include specific metrics and tools defined for the culture system 508 only. Also, all the systems namely strategy system, portfolio system, process system may link to the culture system to define the specific roles of Leaders, Champions and Geniuses.

The culture system 508 may comprise the following component worksheets and templates:

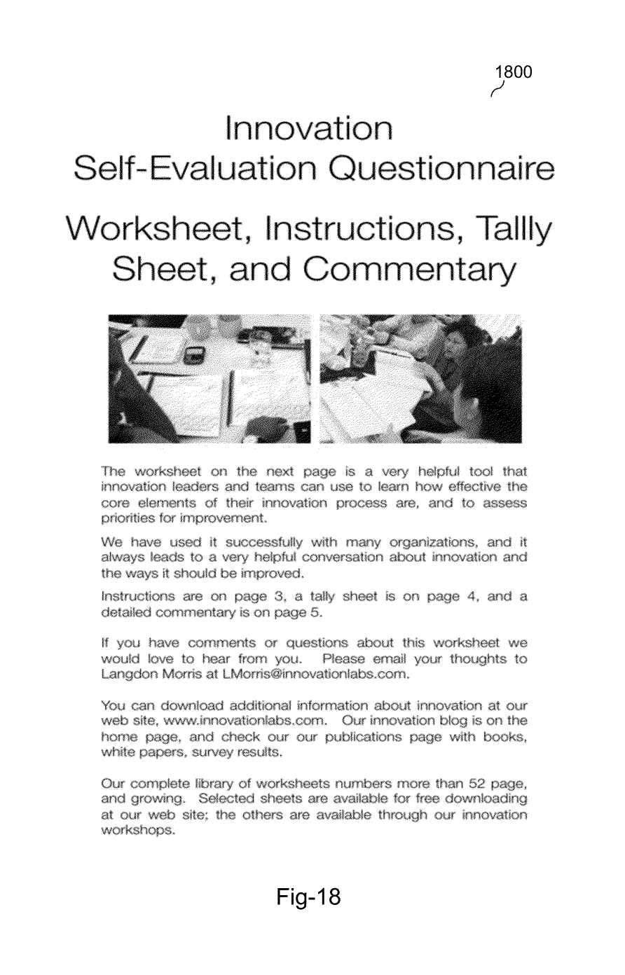

A culture system component, the innovation self-evaluation cover sheet 1800, for explaining the self-evaluation process, is shown in FIG. 18.

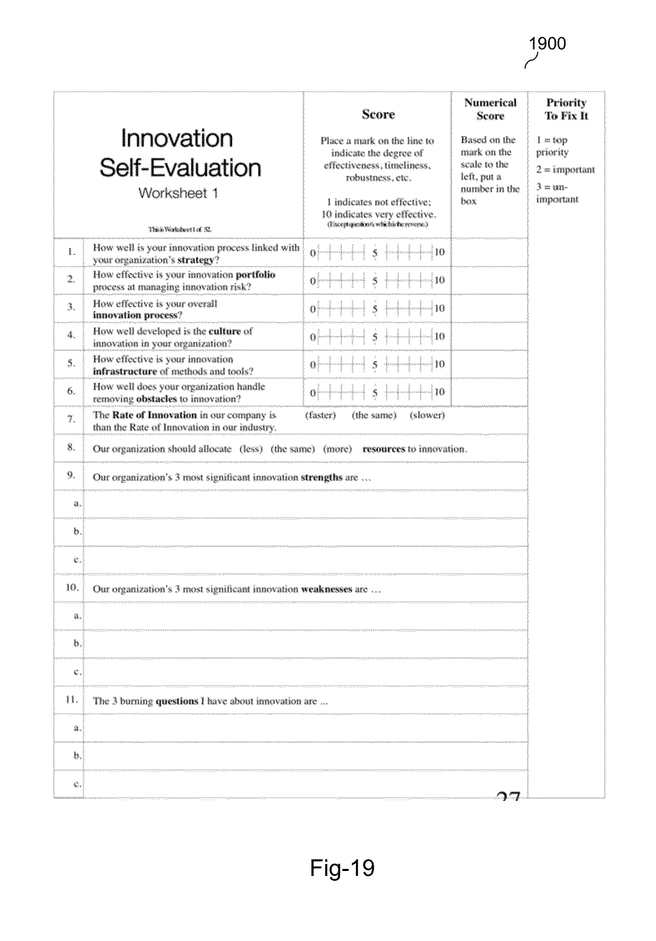

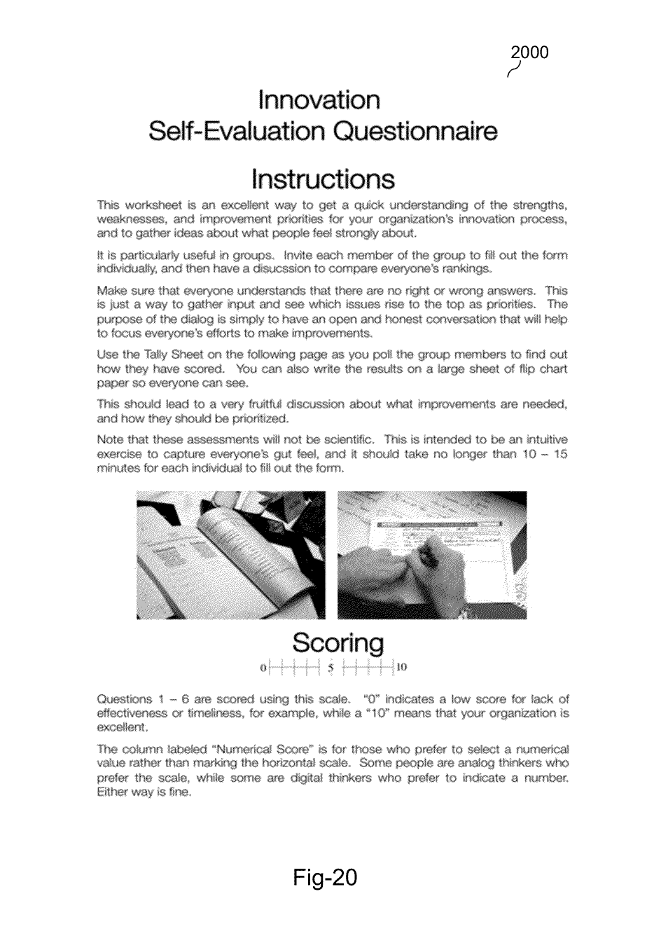

Another culture system component, ‘innovation self-evaluation worksheet 1’ 1900 for self-evaluating innovation, is shown in FIG. 19. Further, another component, the innovation self-evaluation instructions 2000 for explaining the self-evaluation questionnaire, is illustrated in FIG. 20. Another culture system components may be ‘tally sheet’ for scoring self-evaluation; ‘innovation self-evaluation question comments’ for explaining questions on questionnaire; ‘innovation master plan framework’ for providing an overview to master plan framework; ‘what is your view of innovation worksheet’ for ranking innovation; ‘leadership assessment’ for assessing leadership; and ‘innovation leaders worksheet’ for ranking leadership aspects.

Further, there may be additional culture system components, namely—‘innovation leader's worksheet 2’ for ranking behaviors and attitudes; ‘innovation leader's worksheet 2a’ for describing significant behaviors; ‘innovation champions worksheet 1’ for identifying significant behaviors; ‘innovation champions worksheet’ for ranking champion aspects; ‘innovation champions worksheet 2’ for ranking champion attributes; ‘creative geniuses worksheet’ for assess genius aspects; ‘innovation geniuses worksheet 2’ for ranking the innovation cycle; ‘our master plan for strategy’ for targeting innovation strategy; ‘our master plan for process’ for targeting innovation process; ‘our master plan for portfolio’ for targeting portfolio innovation; ‘our master plan for culture’ for targeting innovation culture; and ‘our master plan for infrastructure’ for targeting innovation infrastructure; ‘failure worksheet’ for looking at the role failure plays in innovation; ‘why worksheet’ for describing why innovation is necessary.

Further, as shown in FIG. 5, the system 100 may also comprise an infrastructure system 510. The infrastructure system 510 may comprise an Open Innovation Manager 510a, which may be linked to the Idea Collection Manager 506a in the process system 506. Further, the infrastructure system 510 may also comprise a Virtual Workplace Manager 510b, a Physical Workplace Manager 510c, and a Facilitation Manager 510d. Furthermore, the infrastructure system 510 may also comprise specific metrics and tools defined for the Infrastructure system 510 only. Additionally, a complete Online Tutorial 510e may be available throughout the system 100.

The infrastructure system 510 may comprise following component worksheets and templates:

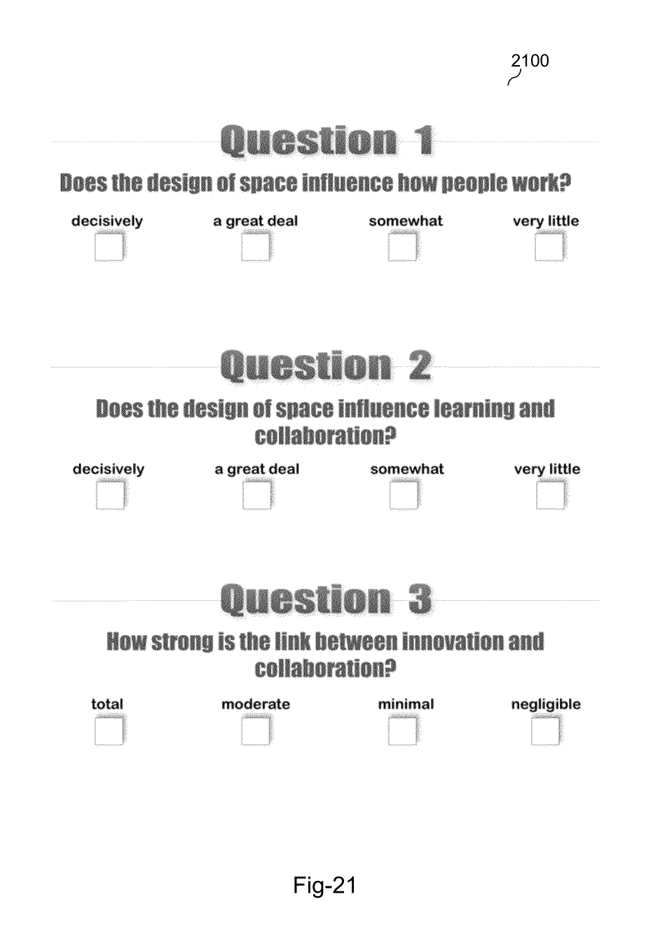

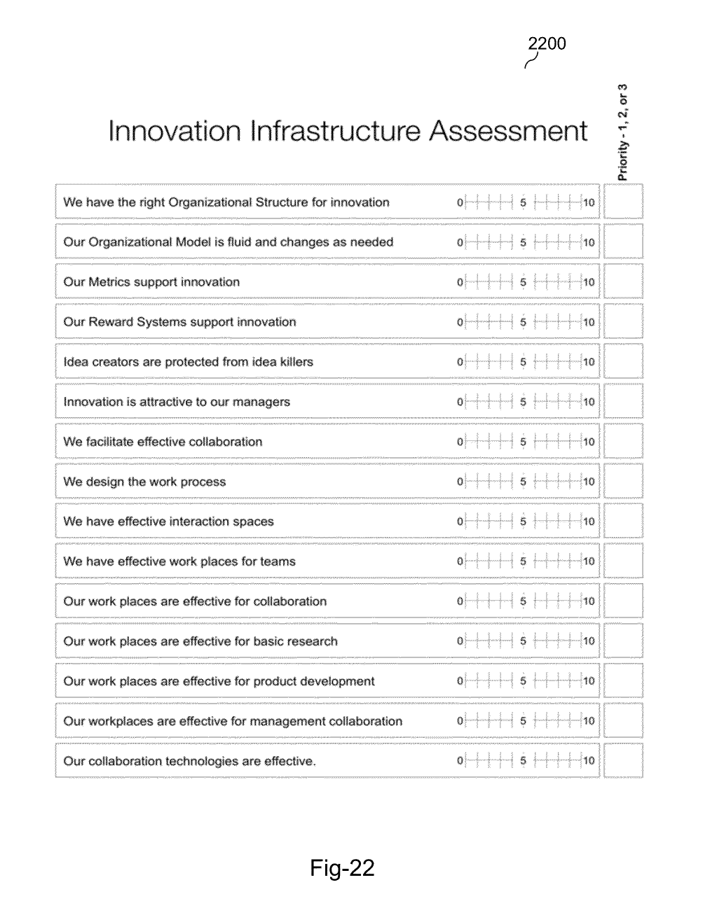

An infrastructure system component may be the 3 questions worksheet 2100 for assessing innovation infrastructure, as shown in FIG. 21; and the innovation infrastructure assessment 2200 for assessing innovation infrastructure, as shown in FIG. 22.

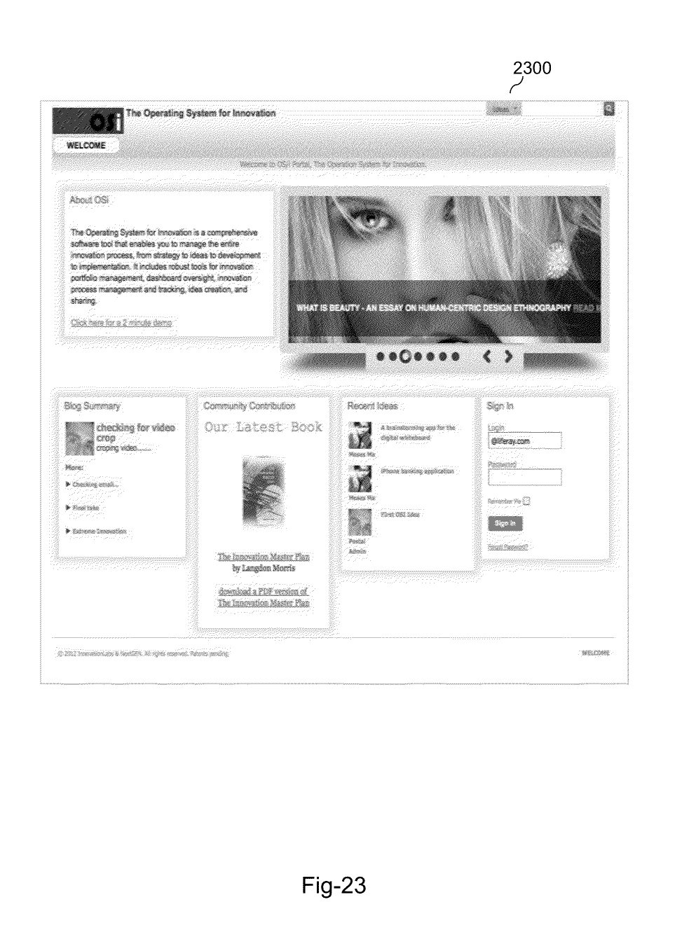

Further, the system 100 may provide coaching, training and guidance to all the users on demand using the online tutorial 510e of the infrastructure system 510. In an embodiment of the invention, the system 100 may possess embedded training modules via integrated video teaching tools 2300, as shown in FIG. 23, which may be accessible by all the users in an organization. In another embodiment, the system 100 may include context-sensitive, integrated training tutorials for each business process.

Further, as shown in FIG. 5, the system 100 may also include a dashboard 512 that is intuitively visual of each and every innovation project. Information from all the systems, namely 502, 504, 506, 508 and 510, and users may be accessible via a dashboard system 512. Access to the dashboard 512 may vary according to the individual user as permissions for access can be adjusted.

The system 100 may define metrics respective to each of the major elements 502, 504, 506, 508 and 510. Following may be the metrics defined for the respective systems:

Metrics for strategy module 502:
How much time do senior managers invest in innovation?
What is the average time required from development of a strategic concept to operational implementation as an innovation?
How much capital do we invest in innovation?
How much money do we invest in each type of innovation?
What business growth do we expect from the innovation process, in percent, and in dollars?

Metrics for portfolio system 504:
What is the rate of introducing breakthroughs?
What is the rate of developing new brands?
What is the alignment of metrics with rewards and reward systems?
What is the ratio of capital invested in the early stages vs. return earned in the sales stage?
What is the actual portfolio composition in the sales stage compared with planned/intended portfolio composition in the planning stage?

Metrics for process system 506:
What is the rate of idea sharing?
What is the number of customer groups explored?
What is the number of instances of research results applied in new products, services, and processes?
What is the breadth of participation from throughout the organization in the research process?
How much time has our organization invested in research?
How much money has our organization has invested in research?
How many ideas have been developed through prototyping?
How many ideas have been contributed by our staff?
What is the percent of new ideas that we work on coming from outside?
How many people inside the organization are participating in the innovation process?
How many people from outside the organization participating in the innovation process?
How many ideas were collected in the ‘idea gathering’ system?
How many collected ideas were developed further?
How many collected ideas from the ‘idea gathering’ system were brought to market?
What percent of the ideas brought to market came through the strategy-portfolio-research pathway, compared with the percent that originated from the open door idea gathering system?
What is the average length of time it takes to get ideas through research and into development?
What is the percent of investment in non-core innovation projects?
What is the total amount invested in non-core innovation projects?
How much senior management time was invested in growth innovation as compared with incremental innovation?
What percent of ideas were funded for development?
What percent of the ideas in the research process were killed?
How many project failures were there per year?
What was the average time to complete and test new prototypes?
How many prototypes were made per new product?
How many patents were applied for in the past year?
How many patents were received in the last year?
What is the return on our marketing investment?
What is the number of new customers added in the last year?
What is the growth rate of our customer base?
What is the average age of the products/services we are currently selling?
What is the gross sales revenue attributable to innovation?
What is the gross sales margin attributable to innovation?
What is the number of new products/services that we have launched in the past year?
What are the expected sales results compared with actual results?
How much cost savings were achieved in the organization due to innovation efforts?
What is the average time to market from research through to sales
What is the level of customer satisfaction with new products/services?

Overall system metrics:
What is the total innovation investment, managed through portfolios?
What is our sales growth?
What is our profit growth?
What is our overall innovation ROI?
What percent of revenue in core categories comes from new products/services?
What percent of revenue in new categories comes from new products/services?
What is the overall percent of new customers from new products/services that is attributable to innovation?
What is the average time to market from research through to sales?
What is the level of customer satisfaction with new products/services?
What percent of projects were terminated at each stage?
How many people are participating in innovation training?
How many people are using online innovation tools?

Advantageously, the present invention may provide a system that may possess a systematic, top-down, dashboard driven overview of the entire innovation management and every portion of it. Further, the system may provide a bottom-up approach to accelerate the contribution of ideas. Furthermore, the system may provide a dashboard that may enable a manager in an organization to review, weigh and select from a collection of ideas. Additionally, the managers may be enabled to track progress of ideas and innovations along an innovation portfolio, by utilizing the system's major element called as portfolio system.

The present invention may provide for large scale information display in a war room environment, such that a large number of people may advantageously use the system simultaneously to “war game” the innovation portfolio by dynamically reconfiguring key variables and data in the system pertinent to external change, or the Strategic Value Calculation algorithms, such that they may be able to better understand their strategic options in response to rapidly changing external conditions, and therefore make better choices as to which innovations are most important, and to dynamically relocate their innovation investment portfolios.

Further, the present invention may disclose a software system for innovation management that may provide a complete online tutorial to users in the organization. Coaching and guidance may also be provided to the users on demand. The online tutorial system may include the capability to adaptively respond to the user's knowledge of innovation and intelligently suggest themes or topics for further study based on gaps in the current knowledge or capability. Further, such capability may then aggregate data from multiple users to identify trouble hot spots for management to address. This functionality may be access through the Culture system 508, where data may be aggregated for each type of user, namely Leaders, Champions, and Geniuses.

Furthermore, the system may be properly aligned with the culture of the organization, to make the organization action oriented and help people possess a ‘make it happen’ approach towards any innovation project.

Consequently, the present invention may propose a comprehensive computer system for innovation management that may be used by managers and innovators of an organization.

Since other modifications and changes varied to fit particular operating requirements and environments are apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

Although the invention has been explained in relation to its preferred embodiment, it is to be understood that many other possible modifications and variations can be made without departing from the spirit and scope of the invention as herein described.

As one of ordinary skill in the art may appreciate, the example system and method described herein can be modified. For example, certain steps can be omitted, certain steps can be carried out concurrently, and other steps can be added. Although particular embodiments of the invention have been described in detail, it is understood that the invention is not limited correspondingly in scope, but includes all changes, modifications and equivalents coming within the spirit and terms of the claims appended hereto.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1-2. (canceled)

3. A computer software system, said computer software system to be used by a plurality of users, each user having a user's device; said computer software system capable of being used to better manage an innovation process; said computer software system comprising:
a category, said category comprising a set of leaders, a set of champions, and a set of geniuses;
a culture system, said culture system comprising a set of culture metrics and a set of culture tools;
an infrastructure system, said infrastructure system comprising set of infrastructure metrics and a set of infrastructure tools;
a strategy system, said strategy system comprising a set of strategy system role definitions for each of said leaders and for each of said champions;
a portfolio system, said portfolio system comprising a set of portfolio metrics and a set of portfolio tools, said portfolio system additionally comprising a set of specific portfolio system role definitions for each of said leaders, for each of said champions, and for each of said geniuses;
a process system, said process system comprising a set of process metrics and a set of process tools, said process system have a set of specific process system role definitions for each of said leaders, for each of said champions, and for each of said geniuses
wherein said portfolio system capable of interfacing with said culture system, and with said strategy system;
said process system capable of interfacing said culture system, said strategy system, and said portfolio system;
said strategy system capable of interfacing with of said culture system, said strategy system, and said portfolio system;
a dashboard, said dashboard allowing each of said users to access said computer software system through said user's device
whereby said computer software system enables at least one user to better manage innovation processes.

4. The computer software system of claim 3 additionally comprising:
an administrative server;
a graphical user interface;
at least one database;
wherein said at least one database being hosted on said administrative server, and wherein at least one user interacts with said computer software system through said graphical user interface hosted on each of said user's device.

5. The computer software system of claim 3 wherein
said strategy system comprising:
an overview assessment worksheet capable of assessing overview;
an exponential change worksheet capable of assessing exponential change;
a change curve worksheet capable of assessing change;
a strategy/digital world worksheet capable of assessing digitization;
a strategy/exponential change worksheet capable of assessing exponential change;
a globalization worksheet capable of assessing globalization;
a strategy/commoditization worksheet capable of assessing commoditization;
said portfolio system comprising:
an ideal innovation portfolio worksheet capable of plotting an innovation portfolio;
a strategic opportunities worksheet capable of ranking strategic factors;
an innovation portfolio evaluation form, for evaluating said innovation portfolio;
an innovation in your industry worksheet capable of assessing innovation within in said industry;
an innovation table worksheet capable of categorizing types of innovation;
a business model innovation attributes worksheet capable of identifying innovation attributes;
business model innovation examples capable of identifying internal innovation examples;
a business model matrix worksheet capable of plotting business models compared with competition;
a reward/risk matrix worksheet capable of plotting reward and risk;
a plurality of types of innovation worksheet capable of ranking innovation methodologies;
said process system comprising:
a workshop action plan worksheet capable of outlining an action plan;
a plurality of innovation drivers worksheet capable of plotting innovation drivers;
a plurality of innovation drivers map a, for plotting current innovation drivers;
a plurality innovation drivers map b, for plotting ideal innovation drivers;
an analytical framework for innovation worksheet capable of assessing an innovation framework;
a needfinding sources worksheet capable of identifying needfinding sources;
a process system component—needfinding examples worksheet capable of identifying needfinding examples;
an ideation worksheet capable of collecting thoughts and comments;
said culture system comprising:
an innovation self-evaluation cover sheet for explaining a self-evaluation process;
an innovation self-evaluation worksheet capable of self-evaluating innovation;
an innovation self-evaluation instructions for explaining an self-evaluation questionnaire;
a tally sheet, for scoring self-evaluation;
an innovation self-evaluation question comments for explaining questions on questionnaire;
an innovation master plan framework for providing said overview to master plan framework;
a what is your view of innovation worksheet capable of ranking innovation;
a leadership assessment worksheet capable of assessing leadership;
an innovation leaders worksheet capable of ranking leadership aspects;
a second innovation leaders' worksheet capable of ranking behaviors and attitudes;
a third-innovation leader's worksheet capable of describing significant behaviors;
a first innovation champions worksheet, for identifying significant behaviors;
a second innovation champions worksheet capable of ranking champion aspects;
a third innovation champions worksheet capable of ranking champion attributes;
a creative geniuses worksheet capable of assess genius aspects;
an innovation geniuses worksheet capable of ranking an innovation cycle;
a strategy for our master plan for targeting innovation strategy;
process for our master plan for targeting said innovation process;
a portfolio for our master plan for targeting portfolio innovation;
a culture for our master plan for targeting innovation culture;
an infrastructure for our master plan for targeting innovation infrastructure;
said infrastructure system comprising:
a failure worksheet capable of looking at how role failure correlates with innovation;
a why worksheet capable of describing why innovation is necessary;
a plurality of questions worksheet capable of assessing innovation infrastructure; and
an innovation infrastructure assessment worksheet capable of assessing innovation infrastructure.
